(19) United States
(12) Patent Application Publication
(10) Pub. No.: US 2019/0210156 A1
(43) Pub. Date: Jul. 11, 2019

(54) WORK FIXTURE, DEVICE AND METHOD FOR MACHINING THE CUTTING EDGE OF CUTTING TOOLS

(71) Applicant: Beijing University of Technology, Beijing (CN)

(72) Inventors: Lingfei Ji, Beijing (CN); Wenhao Wang, Beijing (CN); Tianyang Yan, Beijing (CN); Rui Jiang, Beijing (CN); Sicong Wang, Beijing (CN); Zhenyuan Lin, Beijing (CN); Qiang Yang, Beijing (CN)

(21) Appl. No.: 15/574,503

(22) PCT Filed: Nov. 18, 2016
(86) PCT No.: PCT/CN2016/106316

§ 371 Date: Nov. 16, 2017

(30) Foreign Application Priority Data
Nov. 11, 2016 (CN) 201610993833.1

(51) Int. Cl. B23K 26/40; B23K 26/082

(52) U.S. Cl. CPC B23K 26/40; B23K 2101/20; B23K 26/082

(57) ABSTRACT

The present invention discloses a work fixture, a device and a method for machining the cutting edge of cutting tools. The work fixture comprising: rotatable beveled base inside the fixture shell, the angle of the beveled base can be adjusted by the angle adjusting device; a feeding plate on the beveled base, on which a plurality of grooves are equispaced on the plate for clamping the cutting tools to be machined and completing the machining of the cutting edge. The device and the method of the present invention comprising: a controller being connected with a laser and a laser galvanometer, respectively; the beam of the laser sequentially passing through the reflection lens and the laser galvanometer to make the incident direction perpendicular to the datum plane and shot on the cutting tool to be machined on the feeding plate, and completing the machining of the cutting edge. Wherein, the laser parameters include a wavelength of 100 nm˜1064 nm, 10.6 um; an average pulse power of 1 W˜500 W; a pulse width of 10 ps˜300 ns; and a repetition frequency of 200 kHz˜10 MHz. The present invention can obtain the required cutting edge by laser cutting the cutting part once, with which the output and the efficiency are greatly improved and the cost is reduced. All the indicators, such as the obtained cutting edge, the roughness and the machining precision are also improved significantly.

### TECHNICAL FIELD

The present invention relates to the field of laser precision machining, and more particularly to a work fixture, a device and a method for machining the cutting edge of cutting tools.

### BACKGROUND OF THE INVENTION

As a kind of superhard cutting tool material, diamond has been used in cutting machining for hundreds of years. In the course of the development of cutting tools, from the late 19th century to the middle of the 20th century, the high-speed steel is the main representative of cutting tool materials. In 1927, Germany first developed cemented carbide cutting tool material and had it widely used; In the twentieth fifties, Sweden and The United States developed synthetic diamond respectively, indicating that cutting tools have entered an area where the superhard material is the representative. In the twentiethseventies, polycrystalline diamond (PCD) was synthesized by high-pressure synthetic technology, which solved the problem of scarce and expensive natural diamond, and extended the application of diamond cutting tools to aviation, aerospace, automobile, electronics, stone and many other areas.

Even it has many excellent properties, the forming machine of Polycrystalline diamond is very difficult because of the high hardness, good wear resistance, and this seriously hindered its application. Therefore, it is very important to study its machining method. The United States, Britain, China, Japan, Germany, South Africa, Switzerland and France and other countries are conducting research in this area. The main methods applied currently are grinding, lapping, EDM machining, laser machining, electrochemical machining, ultrasonic machining and composite machining.

During the grinding machining, due to the high hardness of diamond knife, there is a lot of difficulties in the machining. At first, because the material grinding requires a high grinding pressure, the initial grinding pressure of the material is more than 10 times of cemented carbide. Secondly, the grinding efficiency is very low and the grinding wheel consumption is very large. The grinding ratio is only 0.001˜0.025, only 1/1000˜1/100000 of cemented carbide.

As one of the most traditional machining methods, the efficiency of diamond grinding is very low.

EDM machining needs the materials to be conductive materials and can do nothing to non-conductive materials. Generally, it is used to machining the PCD blank. The efficiency is also very low and cannot be used for actual production.

Ultrasonic machining needs to work with grinding, and so does the chemical machining and the mechanical machining. Both of them cannot be achieved with direct removal.

The traditional mechanism of laser machining of diamond: the mechanism of laser machining of diamond is the laser beam with very high energy density shot on the diamond surface, then part of the laser energy is absorbed by the surface and converted into heat. The local temperature of the irradiated spot quickly rose to million degrees, so that the local part of the diamond material melted or even vaporized and foimed pit. At the same time, the heat diffusion began. As a result, the material around the spot also melted. With the continued absorption of laser energy, the steam in the pit inflated and the pressure increased. The liquid melt ejected at a high speed in the foil of an explosion. The recoil pressure produced by the ejection then forms a strong directional shock wave inside the workpiece. Therefore, the diamond corrodes part of the material under the action of the high temperature melt and vaporization and the shock wave and forms laser corrosion pit. The laser parameters that play a decisive role in laser machining materials are pulse width, maximum pulse power and average pulse power. Since the mechanism uses high-energy density of heat machining of the laser, there will be micro-graphite layer on the diamond surface of the machining and refinement is needed. Thus, the traditional laser machining usually used in the rough machining of the diamond.

Therefore, it is of great significance to propose an efficient method to mass produce diamond cutting tools. Chinese patent application CN200810201484.0 discloses a diamond complex crystal lockable four-face knife and the manufacturing method thereof. With the cutting line or laser cutting diamond polycrystalline into tetrahedron, the diamond complex crystal lockable four-face knife is then refined from it. Chinese patent CN201410401572.0 discloses a method for machining the cutting edge. Through grinding or discharge wire machining the material, it obtains the cutting part, and then applying the laser action to improve the smoothness and straightness of the cutting edge. International patent WO2015195754A1 discloses a device for laser leaching of PCD and an operation method thereof. Although the related existing technology can machining simple shape, the efficiency and the accuracy is quite low and the laser machining cannot be used directly to obtain the standard cutting edge that with good roughness, high precision and can be used directly.

With the development of laser technology, in the late of 80-90 s of 20th century, there have been a variety of commercial lasers. And with the continuous improvement of the basic technical parameters, the lasers are expected to bring a breakthrough leap in the aspect of taking account of the efficiency when precision machining the material. Good Stability and relatively low equipment acquisition and maintenance costs make lasers have a very broad application prospects in the industrial field and form a new removal manufacturing science, which has the advantage of high efficiency and precision that no other types of lasers can achieve.

### SUMMARY OF THE INVENTION

In view of the shortcomings in the above-mentioned problems, the present invention provides a work fixture, a device and a method for machining the cutting edge of cutting tools.

In order to achieve the above object, it is a first object of the present invention to provide a work fixture for machining the cutting edge of cutting tools which comprises: a fixture shell;

a rotatable beveled base, being inside the fixture shell;

an angle adjusting device with readings, arranged on the fixture shell's side wall, and being connected with the beveled base in order to adjust the angle of the beveled base;

a feeding plate, arranged on the beveled base, and a plurality of grooves being equispaced on the feeding plate;

the grooves comprising a first tank and a second tank communicating therewith. The first tank using to clamp the cutting tools to be machined and to maintain the cutting edge of the cutting tools to be machined inside the second tank, the second tank using to provide place for the machining of the cutting edge and to make sure that the feeding plate does not block the incidence of the laser machining the cutting edge.

As a further improvement of the present invention, two beveled bases are arranged correspondingly and each of the two beveled bases being connected with an angle adjusting device.

The second object of the present invention is to provide a device for machining the cutting edge of cutting tools. It comprises: the work fixture according to claim 1, controller, laser, reflection lens and laser galvanometer;

the controller being connected with the laser and the laser galvanometer respectively;

the controller being used to set laser parameters and to control the path of laser scanning by the laser galvanometer;

the beam of the laser sequentially passing through the reflection lens and the laser galvanometer to make the incident direction perpendicular to the datum plane and shot on the cutting tool to be machined mounted on the feeding plate, to complete the machining of the cutting edge of the cutting tool.

As a further improvement of the present invention, the ground surface is used as the datum plane.

As a further improvement of the present invention, the laser mentioned can be one of these lasers: picosecond laser, CO2 laser, fiber laser and YAG laser.

The third object of the present invention is to provide a method for machining the cutting edge of cutting tools. It comprises:
step 1: designing the shape of the grooves according to the shape and machining requirement of the cutting tools to be machined, clamping the cutting tools to be machined inside the grooves;

step 2: adjusting the angle needed for the machining of the cutting edge of cutting tools using the angle adjust device;

step 3: setting laser parameters and laser scanning path through controller, the laser parameters including wavelengths of 100 nm˜1064 nm, 10.6 um, average pulse power of 1 W˜500 W, pulse width of 10 ps˜300 ns and repetition frequency of 200 kHz˜10 MHz; and

step 4: completing the machining of the cutting edge of cutting tools.

As a further improvement of the present invention, the laser parameters include wavelengths of 100 nm˜1064 nm, 10.6 um, average pulse power of 1 W˜20 W, pulse width of 10 ps˜80 ns and repetition frequency of 200 kHz˜10 MHz.

As a further improvement of the present invention, the laser parameters include wavelengths of 355 nm, average pulse power of 15 w, pulse width of 10 ps and repetition frequency of 500 kHz.

As a further improvement of the present invention, the laser parameters include the scanning speed of 800 mm/s as well.

As a further improvement of the present invention, the machining method is suitable for diamond cutting tools, carbide cutting tools, zirconia cutting tools, cubic boron nitride cutting tools and composite cutting tools obtained through sintering and patch welding of the above materials.

Compared with the prior art, the present invention has the advantages that:

The work fixture, the device and the method for machining the cutting edge of cutting tools disclosed by the present invention complete the cutting of the cutting edge of cutting tools through the coordination of the work fixture and laser. The present invention requires only one laser cutting of the cutting part to obtain the required cutting edge and no other auxiliary machining, such as wire cutting, EDM, grinding, etc. are needed. The present invention can be applied to diamonds and other non-conductive materials, can reduce the machining time greatly, can shorten more than half of thetime needed for machining a single cutting tool, can be produced in a massive way, can improve the production and efficiency greatly and reduce costs;

The present invention can coordinate with laser parameters through the work fixture, the cutting thickness can reach more than 1 mm and the cutting angle is controllable, especially in view of the machining of the front and rear angles of cutting tools but not only the front and rear angles;

The roughness, machining precision and all other indicators of the cutting edge obtained from the present invention have significant improvement, such as that the roughness of the surface obtained from the machining of the present invention can reach 1.327 um. Compared with the surface roughness obtained from the existing method (surface roughness obtained from the existing method is more than 2 um), the surface roughness obtained from the present invention's machining has a significant improvement, especially in view of the machining of diamond cutting tools.

### BRIEF DESCRIPTION OF THE DRAWINGS

FIG. 1 is a structure diagram of the work fixture for machining the cutting edge of cutting tools disclosed by one embodiment of the present invention;

FIG. 2 is an enlarged diagram of part A in FIG. 1;

FIG. 3 is a structure diagram of the cutting tool to be machined disclosed by one embodiment of the present invention;

FIG. 4 is a fit diagram of the cutting tool to be machined and the groove disclosed by one embodiment of the present invention;

FIG. 5 is a structure diagram of the device for machining the cutting edge of cutting tools disclosed by one embodiment of the present invention;

FIG. 6 is a diagram of the laser scanning path disclosed by one embodiment of the present invention;

FIG. 7 is a macro-topograph of the cutting tool to be machined after the machining disclosed by one embodiment of the present invention;

FIG. 8 is a topograph of the front cutting edge measured by laser confocal scanning microscopy disclosed by one embodiment of the present invention;

FIG. 9 is a topograph of the roughness of the front cutting edge measured by laser confocal scanning microscopy disclosed by one embodiment of the present invention;

FIG. 10 is a roughness test graph in FIG. 9.

In the figures:

1. fixture shell; 2. beveled base; 3. angle adjusting device; 4. feeding plate; 5. grooves; 52. first tank; 52. second tank; 6. controller; 7. laser; 8. reflection lens; 9. laser galvanometer; 10. cutting tool to be machined; 11. cutting edge of the cutting tool; 12. mark line.

### DETAILED DESCRIPTION OF THE EMBODIMENT

To learn more clearly about the objects, technical means as well as the advantages of the present invention, it will be described in further detail in coordination with the drawings and embodiments. Obviously, the embodiments described here are part of the embodiments and not all. Based on the embodiments in the present invention, all other embodiments obtained by those skilled in the art without departing from the inventive work are within the scope of the present invention.

The present invention relates to a method for machining hard material, and more particularly, to a work fixture, a device and a method for machining cutting edge of cutting tools, which belong to the subject of laser precision machining. The invention can directly cut the superhard material to obtain a cutting edge of the cutting tool (PCD, diamond, but not limited to PCD and diamond) with good roughness, high precision and can be used directly. The cutting thickness can reach more than 1 mm and the cutting angle is controllable, especially for the machining of front and rear angles of the cutting tool (but not limited to front and rear angles). As for the production efficiency, precision, cost and yield of the cutting tools, significant improvement has been done and the objects of rapid production and mass production have been achieved. The present invention relates to various hard materials such as, but not limited to, diamonds, hard alloys, zirconium dioxide, cubic boron nitride, and composite materials obtained through sintering and patch welding of the above materials, such as CVD and CBN.

The present invention will now be described in further detail with reference to the accompanying drawings:

### Embodiment 1

As shown in FIG. 1, the present invention provides a work fixture for machining the cutting edge of cutting tools. It compromises: fixture shell 1, beveled base 2, angle adjusting device 3 and feeding plate 4; Among them:

Fixture shell is a frame structure composed of a bottom plate and a four side plate and there is rotatable beveled base 2 arranged inside the fixture shell 1. The fixture shell 1 has an angle adjusting device 3 with readings arranged on its side wall and the angle adjusting device 3 is connected with the beveled base 2 in order to adjust the angle of the beveled base 2. There are two beveled bases in the present invention and they are arranged correspondingly. Each of the bevel bases 2 is connected with an angle adjusting device 3.

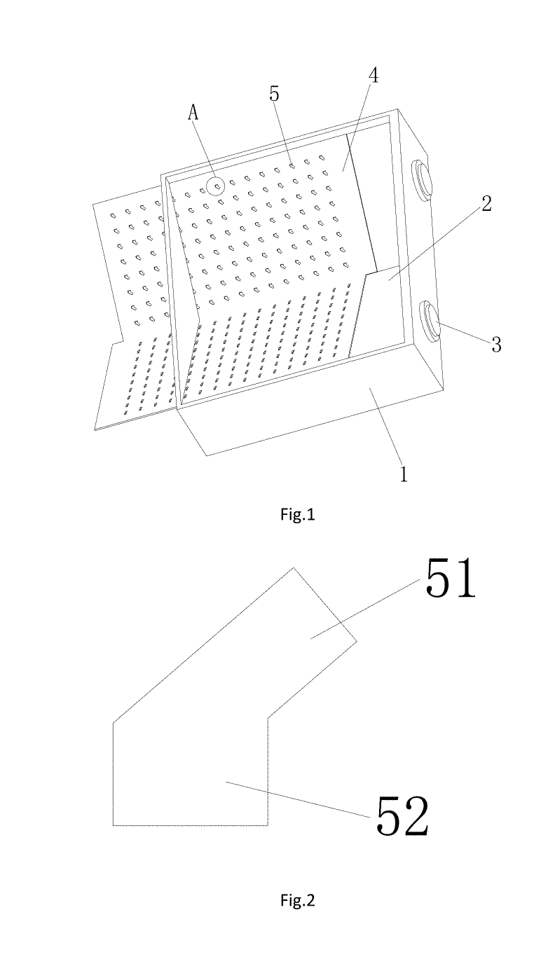

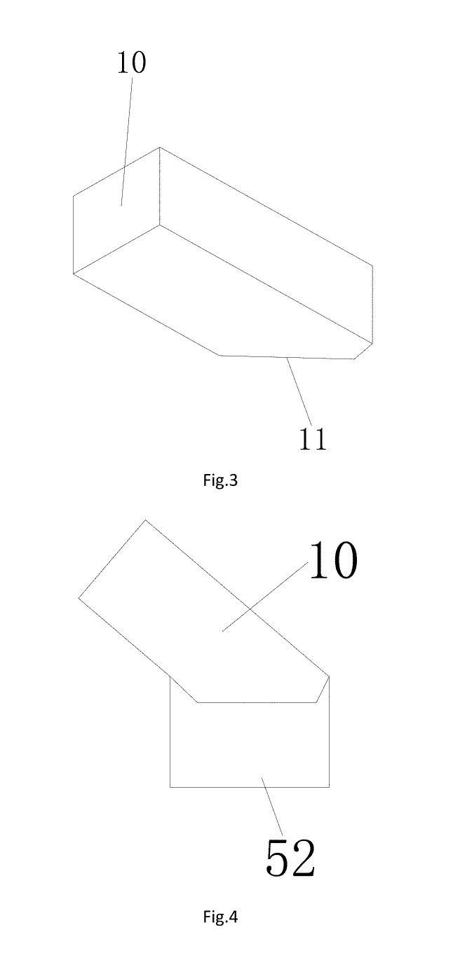

The beveled base 2 of the present invention clamped a feeding plate 4 and the feeding plate 4 can be prepared with a plurality of pieces, which can be fed on the idle plate during machining to meet mass production. The feeding plate 4 has a plurality of grooves 5 equispaced on it. As shown in FIGS. 2-4, the cutting tool to be machined 10 of the present invention has the structure as shown in FIG. 3, and the corresponding feeding plate can be designed according to the shape and machining requirements of the cutting tool to be machined 10. The grooves 5 comprise a first tank 51 and a second tank 52 communicating therewith. The first tank 51 is used to clamp the cutting tools to be machined 10 stably and to maintain the cutting edge of the cutting tools to be machined 11 inside the second tank 52. The second tank 52 provides place for the machining of the cutting edge, and it is slightly longer than the cutting tools to make sure that the feeding plate 4 does not block the incidence of the laser machining the cutting edge.

### Embodiment 2

As shown in FIG. 5, the present invention provides a device for machining the cutting edge of cutting tools. It comprises: the work fixture, controller 6, laser 7, reflection lens 8 and laser galvanometer 9;

The controller 6 is connected with the laser 7 and the laser galvanometer 9 respectively. The controller 6 is used to set laser parameters of the laser 7 and use the laser galvanometer 9 to control the scanning path of laser. The laser beam passes through the reflection lens 8 and the laser galvanometer 9 to make the incident direction perpendicular to the datum plane and shot on the cutting tool to be machined 10 on the feeding plate 4, completing the machining of the cutting edge of the cutting tool 11. The ground surface is the datum plane.

Preferably, the present invention comprises a plurality of lasers, such as, but not limited to, a picosecond laser, a CO₂ laser, a fiber laser, and a YAG laser, which can all use the machining method of cutting edge provided by the present invention. But a picosecond laser is a preferred choice.

### Embodiment 3

The present invention provides a method for machining the cutting edge of cutting tools used in a device for machining the cutting edge of cutting tools. It comprises:

step 1. designing the shape of the grooves according to the shape and machining requirement of the cutting tools to be machined, clamping the cutting tools to be machined inside the grooves;

step 2. adjusting the angle needed for the machining of the cutting edge of cutting tools using the angle adjust device;

step 3. setting laser parameters and laser scanning path through controller. The present invention comprises a set of laser parameter choices, such as, but not limited to wavelengths of 100 nm˜1064 nm, 10.6 um, output power of 1 W˜500 W, pulse width of 10 ps˜300 ns and repetition frequency of 200 kHz˜10 MHz. The parameter mentioned above can apply to the machining method of cutting edge provided by the present invention;

step 4. completing the machining of the cutting edge of cutting tools.

Preferably, the laser parameters include wavelengths of 100 nm˜1064 nm, 10.6 um, average power of 1 W˜20 W, pulse width of 10 ps˜80 ns and repetition frequency of 200 kHz˜10 MHz.

More preferably, the laser parameters include wavelengths of 355 nm, average power of 15 w, pulse width of 10 ps, repetition frequency of 500 kHz and scanning speed of 800 mm/s.

Preferably, the machining method is suitable for diamond cutting tools, carbide cutting tools, zirconia cutting tools, cubic boron nitride cutting tools and composite cutting tools obtained through sintering and patch welding of the above materials.

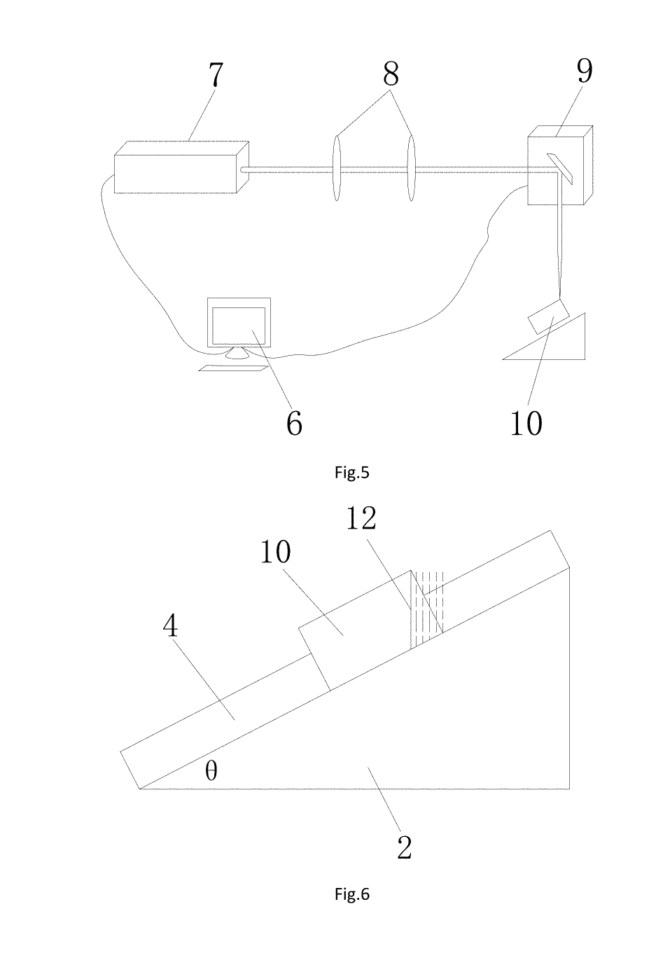

As shown in FIG. 6, the laser beam of the present invention performed by the scanning successively according to the mark of an array of incident lines in the direction of the dotted line on the right side of the mark line 12, and the scanning array width L=1*sin θ, where 1 is the workpiece thickness, θ is the machining angle, and the filling distance is L/m, where m is the size of a spot. The start position of the laser scanning is the rightmost side of the cutting-needed part; when scanning, it is removed from bottom to top, and the length of the laser scanning is the positive deviation of the width of the workpiece.

The present invention comprises a set of mature laser parameters, and the parameters of high frequency, high speed and high power short pulse has better machining effect on diamond cutting tools and PCD cutting tools, such as repetition frequency of 500 KHz, machining speed of 800 mm/s, power of 15 w, and pulse width of 10 ps.

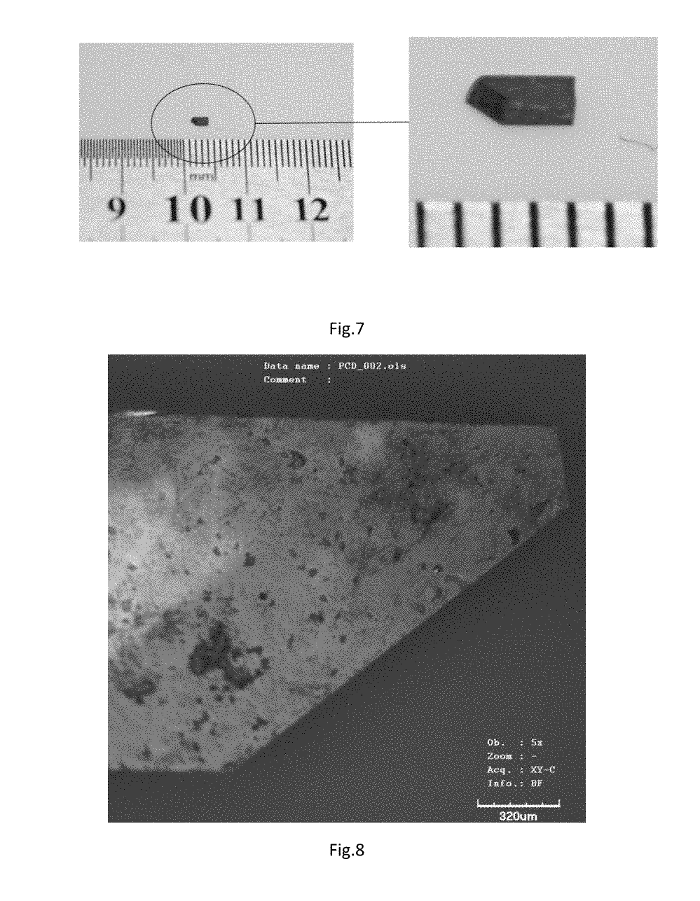

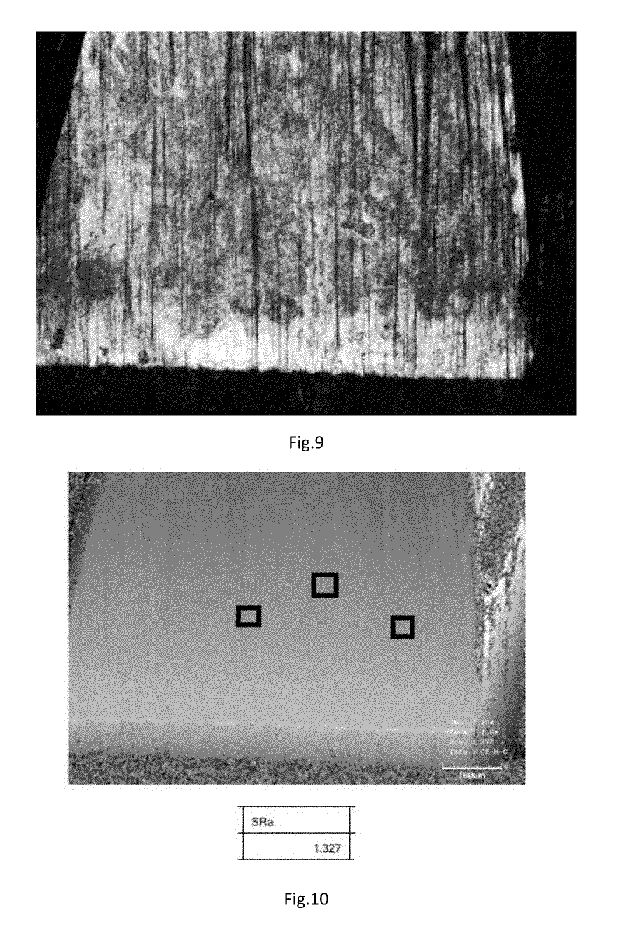

FIG. 7 is a macro-topograph of the cutting tool to be machined after the machining, which is one-time moulded through the above-mentioned machining method. FIG. 8 is a topograph of the front cutting edge under a laser confocal scanning microscope, and the surface of the front cutting edge obtained from the above machining method has a high machining precision. FIGS. 9 and 10 is a topograph of the roughness, and FIG. 10 shows the surface roughness is 1.327 um which is calculated by selecting three test points on the topography of FIG. 9. Compared with the surface roughness obtained from the existing method (surface roughness obtained from the existing method is more than 2 um), the surface roughness obtained from the present invention's machining has a significant improvement.

### Embodiment 4

The present invention is illustrated by taking a 1 mm thick diamond cutting tool and machining the rear angle of 30 degrees as an example; As the structure diagram of the cutting tool to be machined shown in FIG. 3, the long side of the cutting edge is 1.7 mm and the short side is 0.3 mm, and the corresponding rear angles of the long side and the short side are machined through laser cutting.

Feeding plate is made according to the size of the cutting tool to be machined. The first tank of the grooves preserved in the feeding plate is the same as the diamond cutting tool to be machined, so that the cutting tool to be machined can be clamped in the first tank stably. The thickness of the feeding plate is selected to be 0.9 mm, then the second tank, namely the place for machining the cutting edge, should has the length of 0.5 mm and the width of 0.2 mm.

Fix the feeding plate on the beveled base and adjust the angle by the angle adjusting device to ensure the angle is the same as the rear angle to be machined. Make the ground surface as the datum plane and ensure that the laser beam is perpendicular to the datum plane. Use the long side formed by the long side of the workpiece in contact with the base as the start position of the laser scanning.

The laser scanning path is designed. The total length of the scanning array is 0.9/1.73=0.52 mm, the laser array spacing is 0.02 mm, and the scanning array is scanned from the bottom to the top. The width of the scanning array is 1.7 mm, which is the same as the length of the long side.

Choice suitable laser parameters to machine the material. The laser parameters with a wavelength of 355 nm, a scanning speed of 800 mm/s, a repetition frequency of 500 KHz, a power of 15 w and a pulse width of 10 ps were used in this embodiment.

The rear angle of the long side is obtained from the machining, and the plane of the rear angle is perpendicular to the datum plane. The dimension of the rear angle is one of the rear angels of the work fixture adjusted. After the completion of the machining, adjust the angle and clamp the feeding plate correspond with the short side. Repeating the above steps and obtaining the rear angle correspond in the short side.

Using the laser confocal scanning microscope to observe the cutting edge, as the results of the roughness test shown in FIG. 9 and FIG. 10, the surface roughness shown is 1.327 um calculated by selecting three test points on the topography of roughness. Compared with the surface roughness obtained from the existing method (surface roughness obtained from the existing method is more than 2 um), the surface roughness obtained from the present invention's machining has a significant improvement.

### Embodiment 5

The present invention is illustrated by taking a 1 mm thick diamond cutting tool and machining the rear angle of 30 degrees as an example; As the structure diagram of the cutting tool to be machined shown in FIG. 3, the long side of the cutting edge is 1.7 mm and the short side is 0.3 mm, and the corresponding rear angles of the long side and the short side are machined through laser cutting.

Feeding plate is made according to the size of the cutting tool to be machined. The first tank of the grooves preserved in the feeding plate is the same as the diamond cutting tool to be machined, so that the cutting tool to be machined can be clamped in the first tank stably. The thickness of the feeding plate is selected to be 0.9 mm, then the second tank, namely the place for machining the cutting edge, should has the length of 0.5 mm and the width of 0.2 mm.

Fix the feeding plate on the beveled base and adjust the angle by the angle adjusting device to ensure the angle is the same as the rear angle to be machined. Make the ground surface the datum plane and ensure that the laser beam is perpendicular to the datum plane. Use the long side formed by the long side of the workpiece in contact with the base as the start position of the laser scanning.

The laser scanning path is designed. The total length of the scanning array is 0.9/1.73=0.52 mm, the laser array spacing is 0.02 mm, and the scanning array is scanned from the bottom to the top. The width of the scanning array is 1.7 mm, which is the same as the length of the long side.

Choice suitable laser parameters to machine the material. The laser parameters with a wavelength of 100 nm, a scanning speed of 800 mm/s, a repetition frequency of 200 KHz, a power of 1 W and a pulse width of 100 ps were used in this embodiment.

The rear angle of the long side is obtained from the machining, and the plane of the rear angle is perpendicular to the datum plane. The dimension of the rear angle is one of the rear angels of the work fixture adjusted. After the completion of the machining, adjust the angle and clamp the feeding plate correspond with the short side. Repeating the above steps and obtaining the rear angle correspond in the short side.

### Embodiment 6

The present invention is illustrated by taking a 1 mm thick diamond cutting tool and machining the rear angle of 30 degrees as an example; As the structure diagram of the cutting tool to be machined shown in FIG. 3, the long side of the cutting edge is 1.7 mm and the short side is 0.3 mm, and the corresponding rear angles of the long side and the short side are machined through laser cutting.

Feeding plate is made according to the size of the cutting tool to be machined. The first tank of the grooves preserved in the feeding plate is the same as the diamond cutting tool to be machined, so that the cutting tool to be machined can be clamped in the first tank stably. The thickness of the feeding plate is selected to be 0.9 mm, then the second tank, namely the place for machining the cutting edge, should has the length of 0.5 mm and the width of 0.2 mm.

Fix the feeding plate on the beveled base and adjust the angle by the angle adjusting device to ensure the angle is the same as the rear angle to be machined. Make the ground surface the datum plane and ensure that the laser beam is perpendicular to the datum plane. Use the long side formed by the long side of the workpiece in contact with the base as the start position of the laser scanning.

The laser scanning path is designed. The total length of the scanning array is 0.9/1.73=0.52 mm, the laser array spacing is 0.02 mm, and the scanning array is scanned from the bottom to the top. The width of the scanning array is 1.7 mm, which is the same as the length of the long side.

Choice suitable laser parameters to machine the material. The laser parameters with a wavelength of 1064 nm, a scanning speed of 800 mm/s, a repetition frequency of 10 MHz, a power of 500 w and a pulse width of 300 ns were used in this embodiment.

The rear angle of the long side is obtained from the machining, and the plane of the rear angle is perpendicular to the datum plane. The dimension of the rear angle is one of the rear angels of the work fixture adjusted. After the completion of the machining, adjust the angle and clamp the feeding plate correspond with the short side. Repeating the above steps and obtaining the rear angle correspond in the short side.

### Embodiment 7

The present invention is illustrated by taking a 1 mm thick diamond cutting tool and machining the rear angle of 30 degrees as an example; As the structure diagram of the cutting tool to be machined shown in FIG. 3, the long side of the cutting edge is 1.7 mm and the short side is 0.3 mm, and the corresponding rear angles of the long side and the short side are machined through laser cutting.

Feeding plate is made according to the size of the cutting tool to be machined. The first tank of the grooves preserved in the feeding plate is the same as the diamond cutting tool to be machined, so that the cutting tool to be machined can be clamped in the first tank stably. The thickness of the feeding plate is selected to be 0.9 mm, then the second tank, namely the place for machining the cutting edge, should has the length of 0.5 mm and the width of 0.2 mm.

Fix the feeding plate on the beveled base and adjust the angle by the angle adjusting device to ensure the angle is the same as the rear angle to be machined. Make the ground surface the datum plane and ensure that the laser beam is perpendicular to the datum plane. Use the long side foimed by the long side of the workpiece in contact with the base as the start position of the laser scanning.

The laser scanning path is designed. The total length of the scanning array is 0.9/1.73=0.52 mm, the laser array spacing is 0.02 mm, and the scanning array is scanned from the bottom to the top. The width of the scanning array is 1.7 mm, which is the same as the length of the long side.

Choice suitable laser parameters to machine the material. The laser parameters with a wavelength of 110.6 um, a scanning speed of 800 mm/s, a repetition frequency of 1 MHz, a power of 100 w and a pulse width of 10 ns were used in this embodiment.

The rear angle of the long side is obtained from the machining, and the plane of the rear angle is perpendicular to the datum plane. The dimension of the rear angle is one of the rear angels of the work fixture adjusted. After the completion of the machining, adjust the angle and clamp the feeding plate correspond with the short side. Repeating the above steps and obtaining the rear angle correspond in the short side.

The work fixture, the device and the method for machining the cutting edge of cutting tools disclosed by the present invention complete the cutting of the cutting edge of cutting tools through the coordination of the work fixture and laser irradiation. The present invention requires only one laser cutting of the cutting part to obtain the required cutting edge and no other auxiliary machining, such as wire cutting, EDM, grinding, etc. are needed. The present invention can be applied to diamonds and other non-conductive materials, can reduce the machining time greatly, can shorten more than half of the time needed for machining a single cutting tool, can be produced in a massive way, can improve the production and efficiency greatly and reduce costs. By the coordination between laser parameters and the work fixture, in the present invention, the cutting thickness can reach more than 1 mm and the cutting angle is controllable, especially in view of the machining of the front and rear angles of cutting tools but not only the front and rear angles. The roughness, machining precision and all other indicators of the cutting edge obtained from the present invention have significant improvement, such as that the roughness of the surface obtained from the machining of the present invention can reach 1.327 um. Compared with the surface roughness obtained from the existing method (surface roughness obtained from the existing method is more than 2 um), the surface roughness obtained from the present invention's machining has a significant improvement, especially in view of the machining of diamond cutting tools.

The above-mentioned embodiments are only preferred embodiments of the present invention, however, it cannot be understood to intended to limit the invention. It should be noted that those ordinary skilled in the art can make a number of modifications and improvements. Any modifications, equivalent substitutions, improvements, and the like within the spirit and principles of the invention are intended to be included within the scope of the present invention.

1. A work fixture for machining the cutting edge of cutting tools, characterized in that it comprises:
a fixture shell (1);
a rotatable beveled base (2), being inside the fixture shell (1);
an angle adjusting device (3) with readings, arranged on the fixture shell (1)'s side wall, and being connected with the beveled base (2) in order to adjust the angle of the beveled base (2);
a feeding plate (4), arranged on the beveled base (2), and
a plurality of grooves (5), being equispaced on the feeding plate (4), and each of the grooves (5) comprising a first tank (51) and a second tank (52) communicating therewith, the first tank (51) using to clamp the cutting tools to be machined (10) and to maintain the cutting edge of the cutting tools to be machined inside the second tank (52), and the second tank (52) using to provide place for the machining of the cutting edge and to make sure that the feeding plate (4) does not block the incidence of the laser machining the cutting edge.

2. The work fixture for machining the cutting edge of cutting tools according to claim 1, characterized in that
two beveled bases (2) are arranged correspondingly, each of the two beveled bases (2) being connected with an angle adjusting device (3).

3. A device for machining the cutting edge of cutting tools, characterized in that
it comprises the work fixture according to claim 1, a controller (6), a laser (7), a reflection lens (8) and a laser galvanometer (9);
the controller (6) being connected with the laser (7) and the laser galvanometer (9) respectively;
the controller (6) being used to set laser parameters of the laser (7) and to control the path of laser scanning by the laser galvanometer (9); and
the beam of the laser (7) sequentially passing through the reflection lens (8) and the laser galvanometer (9) to make the incident direction perpendicular to the datum plane and shot on the cutting tool to be machined (10) arranged on the feeding plate (4), to complete the machining of the cutting edge (11) of the cutting tool.

4. The device for machining the cutting edge of cutting tools according to claim 3, characterized in that
the ground surface is used as the datum plane.

5. The device for machining the cutting edge of cutting tools according to claim 3, characterized in that
the laser (7) can be one of these lasers: picosecond laser, CO₂ laser, fiber laser and YAG laser.

6. A method for machining the cutting edge of cutting tools by using the device for machining the cutting edge of cutting tools according to claim 3, characterized in that it comprises:
step 1: designing the shape of the grooves according to the shape and machining requirement of the cutting tools to be machined, clamping the cutting tools to be machined inside the grooves;
step 2: adjusting the angle needed for the machining of the cutting edge of cutting tools using the angle adjusting device;
step 3: setting laser parameters and laser scanning path through the controller, the laser parameters including wavelengths of 100 nm˜1064 nm, 10.6 um, average pulse power of 1 W˜500 W, pulse width of 10 ps˜300 ns and repetition frequency of 200 kHz˜10 MHz; and
step 4: completing the machining of the cutting edge of cutting tools.

7. The method for machining the cutting edge of cutting tools according to claim 6, characterized in that
the laser parameters include wavelengths of 100 nm˜1064 nm, 10.6 um, average pulse power of 1 W˜20 W, pulse width of 10 ps˜80 ns and repetition frequency of 200 kHz˜10 MHz.

8. The method for machining the cutting edge of cutting tools according to claim 7, characterized in that
the laser parameters include wavelengths of 355 nm, average pulse power of 15 w, pulse width of 10 ps and repetition frequency of 500 kHz.

9. The method for machining the cutting edge of cutting tools according to claim 8, characterized in that
the laser parameters include the scanning speed of 800 mm/s as well.

10. The method for machining the cutting edge of cutting tools according to claim 6, characterized in that
the machining method is suitable for diamond cutting tools, carbide cutting tools, zirconia cutting tools, cubic boron nitride cutting tools and composite cutting tools obtained through sintering and patch welding of the above materials.
